(19) United States
(12) Patent Application Publication
(10) Pub. No.: US 2026/0061898 A1
(43) Pub. Date: Mar. 5, 2026

(54) VEHICLE SEAT SYSTEM

(71) Applicant: Tesla, Inc., Austin, TX (US)

(72) Inventors: Cheng Hao Yuan, Fremont, CA (US); Olav Barry Sadoo, Austin, TX (US); Andrew Robert Squires, Holland, MI (US)

(21) Appl. No.: 18/823,622

(22) Filed: Sep. 3, 2024

(51) Int. Cl. B60N 2/23; B60N 2/015; B60N 2/56; B60N 2/803; B60R 21/207

(52) U.S. Cl. CPC B60N 2/23; B60N 2/015; B60N 2/5642; B60N 2/803; B60R 21/207

(57) ABSTRACT

A seat assembly for an automotive vehicle can include a continuous frame securable to a chassis of the automotive vehicle. The continuous frame can include a seat portion, a backrest portion, and a hinge. The hinge can be connected to the seat portion and the backrest portion. The hinge can be configured to flex to allow relative movement of the backrest portion with respect to the seat portion.

### BACKGROUND

In the automotive industry, the evolution of automotive seating has been driven by an increasing emphasis on enhancing user comfort, providing customizable support, and ensuring the safety of vehicle occupants. As the centerpiece of a vehicle's interior ergonomics, the seat must accommodate a wide range of body types, preferences, and seating positions. This necessitates a sophisticated interplay of mechanical components that can reliably adjust to the desired configurations.

Traditional vehicle seats are engineered with a multitude of adjustment mechanisms to cater to these diverse requirements. These mechanisms typically involve a series of levers, sliders, and linkages, each designed to control a specific aspect of the seat's position. The complexity of these systems arises from the need to balance multiple factors, such as the ease of adjustment, the durability of moving parts, and the precision required to maintain the seat's position under dynamic conditions.

The design of seat adjustment systems is further complicated by the need to integrate these mechanisms into the limited space of a vehicle's cabin while maintaining a sleek and unobtrusive appearance. The components must be compact yet strong, capable of withstanding the forces exerted during regular adjustments, as well as the stresses encountered during vehicle operation, including acceleration, deceleration, and impact.

Moreover, the materials used in seat construction must be carefully selected for their durability and ability to endure the repetitive motion and long-term use without degradation. The engineering challenge is heightened by the requirement to keep the weight of the seat assembly to a minimum to avoid compromising fuel efficiency and vehicle performance.

In addition to mechanical considerations, the design of seating systems must also take into account the thermal comfort of occupants, the integration of safety features such as airbags, and the need for aesthetic harmony with the vehicle's overall interior design. Each of these factors adds layers of complexity to the design process.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an isometric view of an automotive vehicle, according to some examples.

FIG. 2 illustrates an isometric view of a seat assembly for an automotive vehicle, according to some examples.

FIG. 3 illustrates a side view of a seat assembly for an automotive vehicle, according to some examples.

FIG. 4 illustrates a side view of a seat assembly for an automotive vehicle, according to some examples.

FIG. 5 illustrates an isometric view of a seat assembly for an automotive vehicle, according to some examples.

FIG. 6 illustrates an isometric view of a portion of a seat assembly for an automotive vehicle, according to some examples.

FIG. 7 illustrates a side view of a seat assembly for an automotive vehicle, according to some examples.

FIG. 8 illustrates a schematic view including one or more components of a seat assembly for an automotive vehicle, according to some examples.

FIG. 9 illustrates a side view of a seat assembly, according to some examples.

FIG. 10 illustrates a side view of a seat assembly, according to some examples.

FIG. 11 illustrates a side view of a seat assembly, according to some examples.

FIG. 12 illustrates a side view of a seat assembly, according to some examples.

FIG. 13 illustrates an isometric view of a seat assembly, according to some examples.

FIG. 14 illustrates a schematic view of one or more systems of an automotive vehicle, according to some examples.

FIG. 15 illustrates a schematic view of one or more systems of an automotive vehicle, according to some examples.

### DETAILED DESCRIPTION

Seat assemblies are commonly used in automotive vehicles and especially in consumer vehicles. Typical seat assemblies include a rigid frame covered in foam and surrounded by a trim layer (often fabric or leather). Some seat assemblies can be configured to move or tilt. Such moving seat assemblies typically include multiple pieces connected by a hinge or linkage allowing movement of a backrest portion to a seat portion. However, such seat assemblies can be relatively time consuming to build and assemble and may not provide sufficient lower back support where the backrest connects to the seat.

This disclosure helps to address these issues (among others) by providing a seat assembly including a single continuous frame including a seat portion, a backrest portion, and a hinge. The hinge can allow the backrest portion to move or tilt with respect to the seat portion such that the continuous frame, though being formed of a single component, can move or flex to allow the seat assembly to be adjusted, as desired by a user or passenger in the automotive vehicle.

The above discussion is intended to provide an overview of subject matter of the present patent application. It is not intended to provide an exclusive or exhaustive explanation of the invention. The description below is included to provide further information about the present patent application.

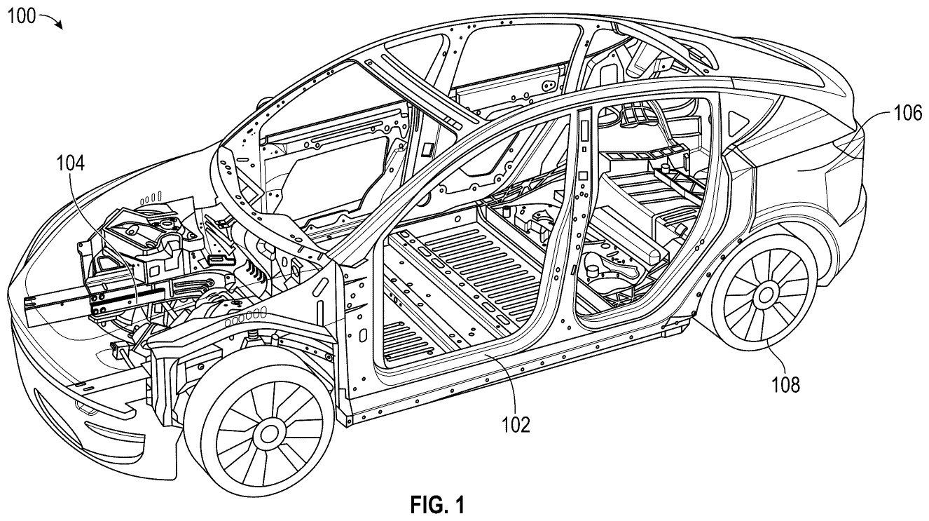

FIG. 1 illustrates an isometric view of an automotive vehicle 100, according to some examples. The automotive vehicle 100 can be a car, vehicle, automobile, or the like, operable to transport occupants or items over a road or other terrain. The automotive vehicle 100 can include a chassis 102, a drivetrain 104, panels 106, and wheels 108. The wheels 108 can engage with a road or terrain and can be configured to support the automotive vehicle 100. The chassis 102 can support the drivetrain 104, which can be connected to the wheels 108. The drivetrain 104 can be operable to drive the wheels 108 to rotate such as to move the automotive vehicle 100. The panels 106 can be connected to the chassis 102 and can help to reinforce the chassis 102 and improve drag or air resistance during transportation. As discussed in further detail below, the automotive vehicle 100 can also include one or more seats or seat assemblies securable to the chassis 102 and configured to support, and help restrain, occupants within the automotive vehicle 100.

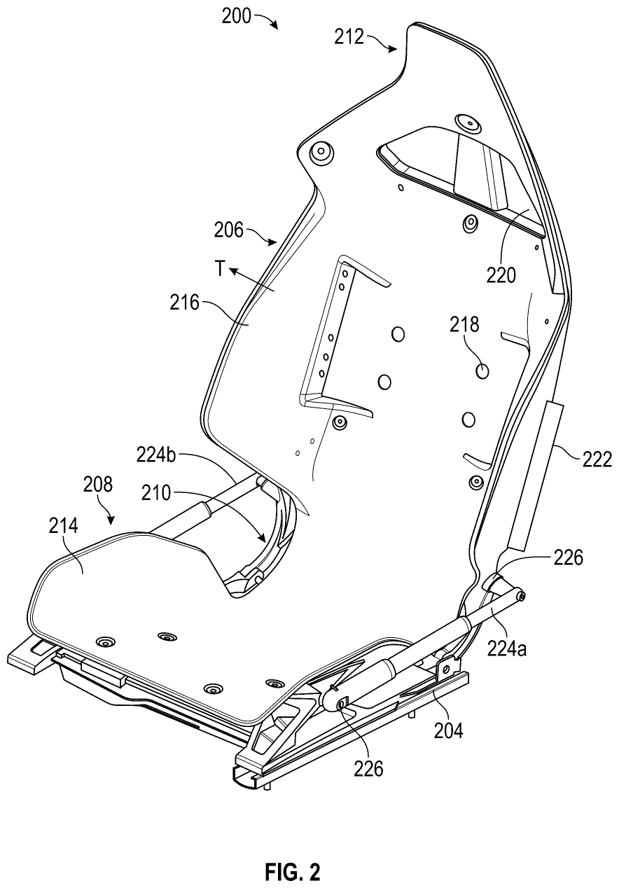

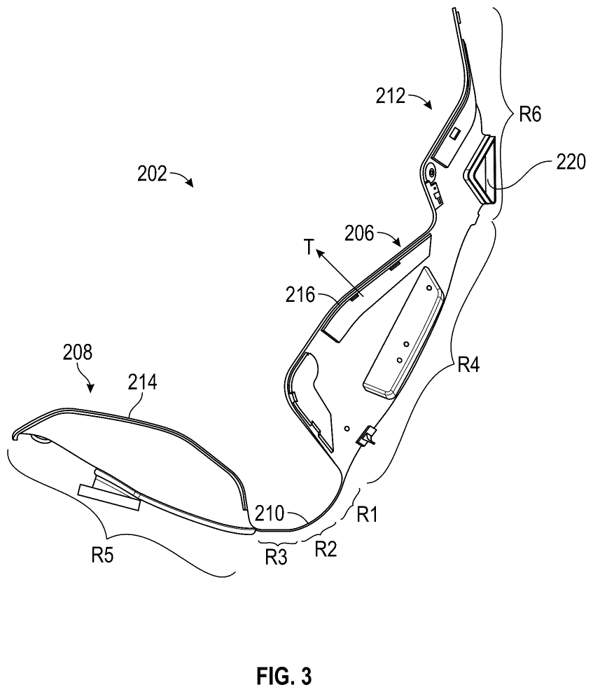

FIG. 2 illustrates an isometric view of a seat assembly 200 for an automotive vehicle (e.g., the automotive vehicle 100), according to some examples. FIG. 3 illustrates a side view of the seat assembly 200, according to some examples. FIG. 2 and FIG. 3 are discussed together below. The seat assembly 200 can include a continuous frame 202, which can be a rigid or semi-rigid frame that can be secured to a frame 204 or rails (that can be secured to the chassis 102) such as to secure the continuous frame 202 to the chassis 102 of the automotive vehicle 100.

The continuous frame 202 can include a backrest portion 206, a seat portion 208, a hinge portion 210, and a headrest portion 212. The seat portion 208 can be connected to a lower portion of the backrest portion 206 by the hinge portion 210, and the headrest portion 212 can be connected to an upper portion of the backrest portion 206. The hinge portion 210 can be configured to flex to allow relative movement of the backrest portion 206 with respect to the seat portion 208, such as reclining, tilting, pivoting, or otherwise moving.

One or more of the backrest portion 206, the seat portion 208, the hinge portion 210, and the headrest portion 212 can be formed as a continuous frame such that the 202 is monolithic or a single continuous component. In some examples, one or more of the backrest portion 206, the seat portion 208, the hinge portion 210, and the headrest portion 212 can be separately formed and connected to the continuous frame 202. For example, the headrest portion 212 can be separately formed and connected to the backrest portion 206.

The continuous frame 202 can be made of a composite, such as an anisotropic composite, that can be molded to a desired shape, such as via thermoforming, to form a monolithic composite structure. For example, the continuous frame 202 can be made of a fiberglass-nylon composite, a fiberglass-polymer composite, a nylon carbon composite, a Kevlar-nylon composite, a Kevlar-polymer composite, or the like. The continuous frame 202 can be made of multiple plies or layers to achieve a desired strength where the plies (or thicknesses thereof) can vary in different areas or portions of the continuous frame 202. The molded composite of the continuous frame 202 can be overmolded by one or more polymers or polymer composites to add one or more features such as clips, hooks, protrusions (e.g., aesthetic or comfort features), fasteners, supports, or the like. Through the design and manufacturing process, stiffness of the backrest portion 206, the seat portion 208, and the hinge portion 210 can be tuned to provide different performance in different portions of the continuous frame 202.

The backrest portion 206 can include one or more backrest bolster 216 (e.g., backrest bolsters 216) that can be connected to opposite lateral sides of the 206. Each of the backrest bolsters 216 can extend at least partially fore or forward of the backrest portion 206. The backrest portion 206 and the backrest bolsters 216 can, together or independently, be configured to support a posterior and lateral portion of a torso, arms, or head of a user, operator, or passenger of the automotive vehicle 100. The backrest bolsters 216 can be formed, together with one or more of the backrest portion 206, the seat portion 208, the hinge portion 210, and the headrest portion 212 as a single continuous component.

Similarly, the seat portion 208 can include one or more seat bolster 214 (e.g., seat bolsters 214) that can be connected to opposite lateral sides of the seat portion 208. The seat bolsters 214 can be seat bolsters or cushions extending from the seat portion 208. The seat bolsters 214 can be located or positioned on opposing sides of the seat portion 208. The seat bolsters 214 can be laterally located or positioned relative to the continuous frame 202 and the seat bolsters 214 can each extend upward such that the seat bolsters 214 are configured to provide lateral upper leg support, such as during turning of the automotive vehicle 100. Together or independently, the seat bolsters 214 can be configured to support the lower portion, e.g., below a waist, such as the posterior and lateral portions of the upper legs of a user, operator, or passenger of the automotive vehicle 100. The seat bolsters 214 can be formed, together with one or more of the backrest portion 206, the seat portion 208, the hinge portion 210, and the headrest portion 212 as a single continuous component.

The continuous frame 202 can define one or more openings, recesses, or other features extending at least partially into or from an outer surface of the continuous frame 202. For example, the continuous frame 202 (e.g., the backrest portion 206) can include or can define one or more ventilation holes 218 extending at least partially into the backrest portion 206 from a fore or forward surface of the backrest portion 206. The ventilation holes 218 can be configured to receive air from, or distribute air to, the seat assembly 200 and therefore a passenger, such as for comfort heating or cooling. The continuous frame 202 can also define a recess 220 extending at least partially into one or more of the backrest portion 206 and the headrest portion 212 to form a recess, hole, opening, or the like. The recess 220 can be configured to receive a soft trim component (or other seat component or module) at least partially therein to secure the soft trim component to the continuous frame 202 and to form a desired shape of the headrest portion 212 and the backrest portion 206, such as for increasing comfort and ergonomics of the continuous frame 202.

As discussed above, and in further detail below, the continuous frame 202 can be configured to flex and move, such as for increasing comfort and ergonomics of the continuous frame 202. The hinge portion 210 can be configured to flex to allow such movement or adjustment of the continuous frame 202. In some examples, the hinge portion 210 can include multiple sections with varying flexibility to help increase a range of movement and flexibility of the continuous frame 202. For example, the hinge portion 210 can include a first region R1 having a first stiffness, a second region R2 having a second stiffness, and a third region R3 having a third stiffness. Also, the backrest portion 206 can include a fourth region R4 having a fourth stiffness, the seat portion 208 can include a fifth region R5 having a fifth stiffness, and the headrest portion 212 can include a sixth region R6 having a sixth fifth stiffness.

Any of the stiffness regions can be the same or can be different. For example, the first stiffness, second stiffness, and third stiffness can be the same or can be different to provide a desired flexibility profile of the hinge portion 210. Also, the hinge portion 210 can have a stiffness region or profile that is different from the stiffness profiles of the fourth region R4, the fifth region R5, and the sixth region R6, such that the hinge portion 210 is more flexible than the backrest portion 206, the seat portion 208, and the hinge portion 210, which can help to enable relative movement of the backrest portion 206 with respect to the seat portion 208.

The backrest bolsters 216 can also be connected to or in contact with one or more airbags 222 or airbag devices. The airbags 222 can be safety devices configured to deploy during an impact or a sudden change in acceleration for passenger safety and protection. The backrest bolsters 216 can be shaped (e.g., as a single continuous component) to guide deployment of the airbags 222. The airbags 222 can be connected to or located near laterally outer or laterally inner portions of the backrest bolsters 216 such as to guide deployment of the airbags 222. For example, when the airbags 222 are deployed, the backrest bolsters 216 can guide deployment along a trajectory T, which can be a desired or predetermined trajectory configured to optimize patient safety or protection. Because the continuous frame 202 (including the backrest bolsters 216) can be a single continuous component, the backrest bolsters 216 can be configured to have a stiffness, shape, or size to achieve the desired trajectory. The backrest bolsters 216 (i.e., left and right) can be configured (e.g., sized or shaped) such that a left bolster airbag deployment trajectory is different than a right bolster airbag deployment trajectory, respectively.

The seat assembly 200 can also include one or more recline actuators 224, which can be a linear actuator, motor, or the like. The recline actuators 224 can be connected to respective lateral sides of the continuous frame 202. For example, the recline actuator 224a can connect to the continuous frame 202 at a top portion of the hinge portion 210 or a bottom portion of the backrest portion 206 or at a location where the hinge portion 210 and the backrest portion 206 meet or connect. The recline actuator 224a can also connect to the seat portion 208, such as to a front or fore portion thereof. The recline actuators 224 can be connected to the continuous frame 202 by joints 226, which can be bearings, pivots, or the like, configured to allow for rotation of the recline actuators 224 with respect to the continuous frame 202.

In operation of some examples, the recline actuators 224 can be configured to control or affect a position of the continuous frame 202. For example, the recline actuators 224 can act as stops to limit movement of the backrest portion 206 with respect to the seat portion 208. The recline actuators 224 can also be operated (e.g., by a controller) to move the backrest portion 206 with respect to the seat portion 208, such as between various positions (e.g., reclined and upright) as discussed in further detail below, where the hinge portion 210 can allow (and can help control) movement of the backrest portion 206 with respect to the seat portion 208.

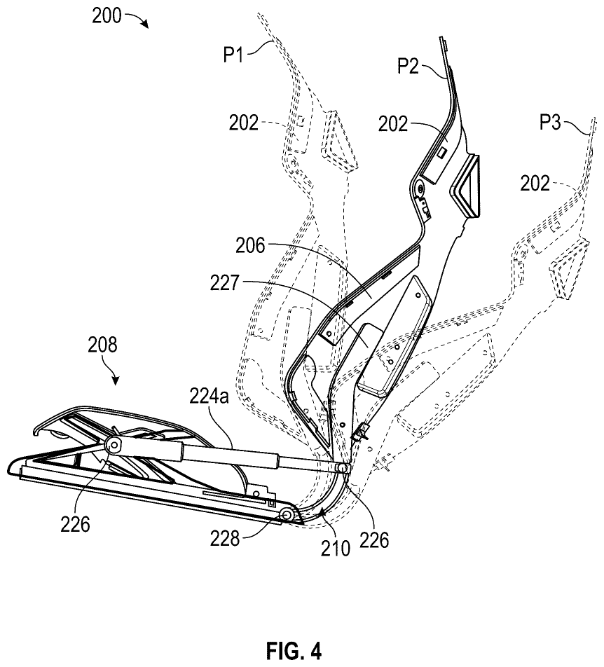

FIG. 4 illustrates a side view of the seat assembly 200 for an automotive vehicle, according to some examples. The seat assembly 200 can be consistent with FIG. 1-FIG. 3 discussed above. FIG. 4 shows how the seat assembly 200 can move. For example, FIG. 4 shows the 206 in an upright position, position P1, a partially reclined position, position P2, and a fully reclined position, position P3.

As discussed above, the seat assembly 200 can include the recline actuators 224 (e.g., recline actuator 224a) connected to the continuous frame 202. The recline actuators 224 can be configured or operable to move the backrest portion 206 relative to the seat portion 208 between the positions P1-P3. Though only positions P1-P3 are shown, the recline actuators 224 can be operated to move the backrest portion 206 in positions between the positions P1 and P3. The recline actuators 224 can also be configured to limit movement of the backrest portion 206 in any one position when the recline actuators 224 are not operated. The recline actuators 224 can thereby limit undesired movement of the backrest portion 206 or fix the backrest portion 206 with respect to the seat portion 208 in any desired position within the range of movement of the backrest portion 206.

As also discussed above, the hinge portion 210 can be configured to enable or support movement of the backrest portion 206 with respect to the seat portion 208. The seat assembly 200 can also include a reinforcement link 227, which can be made of one or more of metals (e.g., aluminum, steel, titanium, or the like), polymers, composites, or the like. The reinforcement link 227 can connected to one or more of the backrest portion 206, the seat portion 208, and the hinge portion 210. The reinforcement link 227 can, in some examples, be integrated into one or more of the backrest portion 206, the seat portion 208, and the hinge portion 210, such as a layer or one or more plies of the continuous frame 202. The reinforcement link 227 can be configured (e.g., shaped or sized) to provide reinforcement through the hinge portion 210, such as to help transfer forces between the backrest portion 206 and the hinge portion 210 and to increase freestanding stiffness of the continuous frame 202.

Optionally, because the reinforcement link 227 can be more rigid than the hinge portion 210, the reinforcement link 227 can also help to locate or define a pivot axis 228. As shown in FIG. 4, the hinge portion 210 can also define the pivot axis 228, or an effective pivot axis of the hinge portion 210 as the hinge portion 210 flexes or moves to support or enable movement of the backrest portion 206. As shown in FIG. 4, the backrest portion 206 can pivot or move about the pivot axis 228 between the positions P1 and P3. The pivot axis 228 can also be configured (located) to be near a virtual pivot or natural pivot axis or point (or points) of the hinge portion 210, which can help reduce stress on the hinge portion 210 and the reinforcement link 227. In some examples, the hinge portion 210 can be configured to locate its virtual pivot point(s) near a designed or ideal location of the pivot axis 228.

The continuous frame 202, which can be constructed of a single continuous component, can be formed in a manner to locate the pivot axis 228 within or of the hinge portion 210 such that the backrest portion 206 moves along a desired trajectory or path, or into various desired positions or locations that are optimized for ergonomics, comfort, and occupant safety. The hinge portion 210 can be designed and manufactured to locate the pivot axis 228 as such. For example, the hinge portion 210 can include variations in thickness, material, number of layers, or the like, to achieve a pivot axis 228 in a desired location.

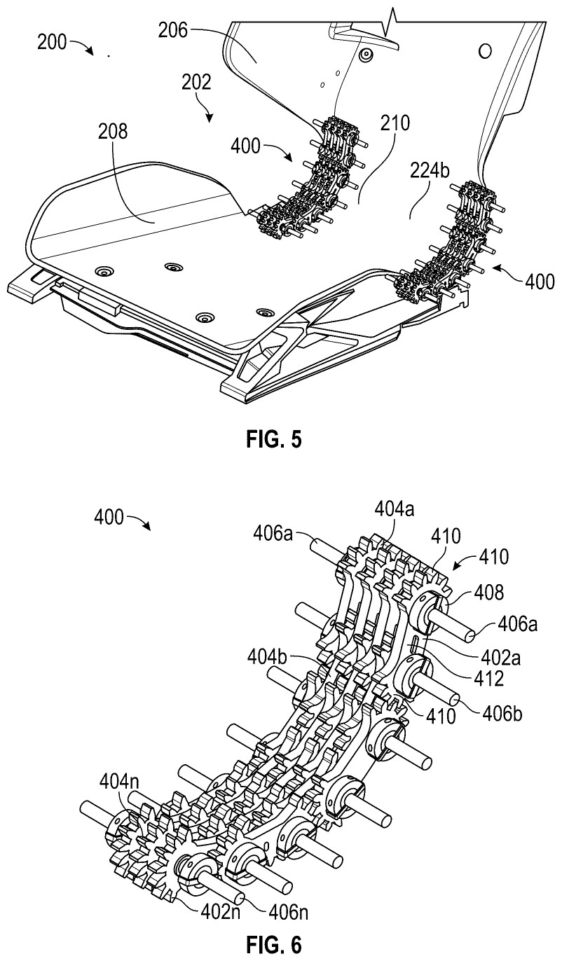

FIG. 5 illustrates an isometric view of a seat assembly 200 for the automotive vehicle 100, according to some examples. FIG. 6 illustrates an isometric view of a linkage assembly 400 of the seat assembly 200 for the automotive vehicle 100, according to some examples. FIG. 5 and FIG. 6 are discussed together below. The seat assembly 200 can be consistent with FIG. 1-FIG. 4 discussed above. FIG. 5 and FIG. 6 show that the seat assembly 200 can include the linkage assembly 400.

As shown in FIG. 5, the linkage assemblies 400 can be connected to a recline actuator 224b of the hinge portion 210, such that a linkage assembly 400 is connected to a first lateral side of the hinge portion 210 and a linkage assembly 400 is connected to a second first lateral side of the hinge portion 210 (e.g., on opposing lateral sides of the hinge portion 210). The linkage assemblies 400 can be connected to the hinge portion 210 to provide a desired flexibility, stiffness, or movement profile of the backrest portion 206 with respect to the seat portion 208.

FIG. 6 shows that the linkage assembly 400 (which can be either of the linkage assemblies 400 of FIG. 5) can include a plurality of links linkages 402a-linkages 402n (collectively referred to as linkages 402). The linkages 402 can be arranged or grouped in linkage groups 404a-404n (collectively referred to as groups 404).

Each group 404 can be located near, next to, adjacent, or intertwined with an adjacent group and each group 404 can be connected to one or more adjacent groups by a rod 406a-406n (collectively referred to as rods 406). The rods 406 can be elongate members that are hollow or solid and generally prismatic in shape. For example, the rods 406 can be cylindrical or hexagonal prisms. The rods 406 can each be configured to receive a retaining ring 408 at least partially thereon to secure groups 404 of links together. For example, the rod 406b can be connected to the group 404a and the group 404b to secure the group 404a to the group 404b. The rods 406 can be connected to the hinge portion 210 to secure the linkage assemblies 400 to the gear 410. In some examples, one or more of the rods 406 can be connected to the seat portion 208 and one or more of the rods 406 can be connected to the backrest portion 206 such as to integrate or connect the linkage assemblies 400 to the continuous frame 202. In some examples, one or more of the rods 406 can be integrally formed into the continuous frame 202. The rods 406 can connect to a front portion of the hinge portion 210, a rear portion of the hinge portion 210, or can be embedded into (e.g., aligned) with the hinge portion 210.

Each of the linkages can include one or more gear 410 and a body 412. For example, the linkage 402a can include a body 412 connected to a gear 410 on each (opposing side). The gears 410 can, in some examples, include holes extending therethrough to receive the rods 406 at least partially therethrough to connect the groups 404 of linkages 402. Gears 410 of adjacent groups 404 of linkages 402 can be engaged with each other such that rotation of on gear or linkage can result in rotation of a gear or linkage of the connected group. This can allow the linkage assemblies 400 to act as a hinge or flexible member when connected to the hinge portion 210.

In some examples, the retaining ring 408 can be or can include a motor. Or, the rods 406 can be connected to one or more motors or actuators to allow the motors or actuators to adjust a position of the hinge portion 210 and therefore of the backrest portion 206 relative to the seat portion 208. By driving individual shafts or rods 406, the seat assembly 200 can be configured to move or flex in complex ways or move or flex to move the continuous frame 202 to a desired position or orientation of the passenger or occupant for increased comfort and ergonomics. With such a construction including the linkage assembly 400, the hinge portion 210 can be constructed of a more flexible (e.g., less rigid) material where the load(s) can be transferred (e.g., between the seat portion 208 and the backrest portion 206) by the linkage assemblies 400. The linkage assemblies 400 can also increase a stiffness of the hinge portion 210 such that the seat assembly 200 has a feeling of increased overall stiffness or rigidity without increasing a thickness of the hinge portion 210.

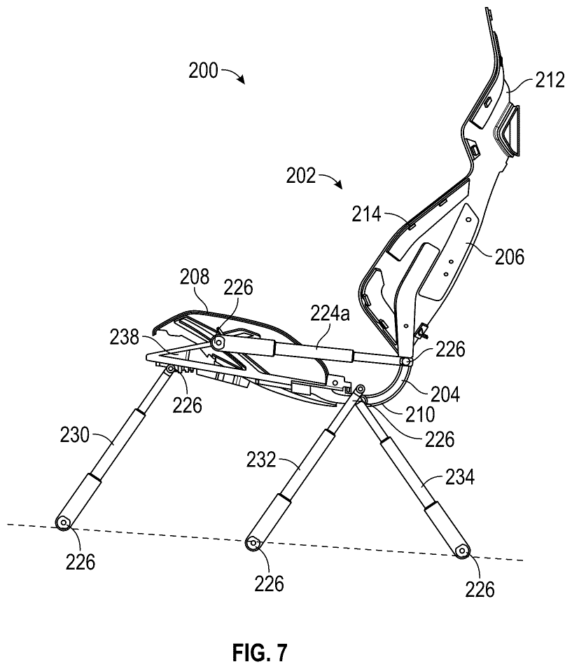

FIG. 7 illustrates a side view of the seat assembly 200 for an automotive vehicle, according to some examples. The seat assembly 200 can be consistent with FIG. 1-FIG. 6 discussed above. FIG. 7 shows that the seat assembly 200 can include the multiple actuators or actuator pairs. For example, FIG. 7 shows that the seat assembly 200 can include fore actuators 230, middle actuators 232, and aft actuators 234.

The fore actuators 230 can be a pair of actuators, linear motors, or the like connected to opposing lateral sides of the seat portion 208 and connected to the chassis (e.g., the 102). The fore actuators 230 can be connected to a fore or front portion of the seat portion 208 and the chassis by joints 226. The middle actuators 232 can be a pair of actuators, linear motors, or the like connected to opposing lateral sides of the seat portion 208 and connected to the chassis (e.g., the 102). The middle actuators 232 can be connected to an aft or rear portion of the seat portion 208 and the chassis by joints 226. The aft actuators 234 can be a pair of actuators, linear motors, or the like connected to opposing lateral sides of the seat portion 208 and connected to the chassis (e.g., the 102). The aft actuators 234 can be connected to an aft or rear portion of the seat portion 208 and the chassis by joints 226. The joints 226 can be bearings, joints, bushings, or the like, configured to allow for relative rotation of the actuators, as discussed above.

FIG. 7 also shows that the actuators (e.g., the recline actuators 224 or the fore actuator 230) can be connected to the seat portion 208 via a reinforcement portion 238. The reinforcement portion 238 can be a rigid or semi-rigid component integrated into or connected to the seat portion 208 (such as to each lateral side of the seat portion 208, such as at a front portion of the seat portion 208). The reinforcement portion 238 can help to provide a higher stiffness or reinforcement of the seat portion 208 at a location where the actuators can connect to the seat portion 208. The reinforcement portion 238 can also provide one or more attachment features (e.g., bosses, threaded bores, or the like) for connecting one or more of the actuators to the reinforcement portion 238.

The recline actuators 224, the fore actuators 230, the middle actuators 232, and the aft actuators 234 can be operable, together or individually, to move the continuous frame 202 or one or more portions thereof relative to other portions of the continuous frame 202 or relative to the chassis 102 of the automotive vehicle 100. The various movements of the continuous frame 202 are discussed in further detail below.

Though four pairs of actuators are shown in the figures, each pair of actuators can be replaced with a single actuator on either lateral side of the continuous frame 202 and the continuous frame 202 can have increased rigidity to handle any asymmetric forces applied to the continuous frame 202 by the single actuators during movement of the continuous frame 202.

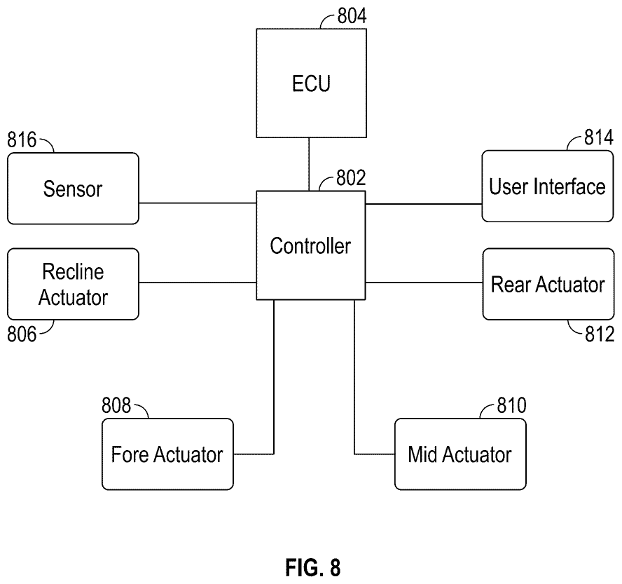

FIG. 8 illustrates a schematic view of a control system of a seat assembly 200 for an automotive vehicle, according to some examples. Specifically, FIG. 8 shows that the automotive vehicle 100 can include a controller 802, which can be a programable controller, such as a single or multi-board computer, a direct digital controller (DDC), a programable logic controller (PLC), printed circuit board (PCB), or the like. In other examples the controller 802 can be any computing device, such as a handheld computer, for example, a smart phone, a tablet, a laptop, a desktop computer, or any other computing device including a processor, memory, and communication capabilities. The controller 802 can be connected to and in communication with an electronic control unit or ECU 804, which can be or can include one or more control systems 1314 of the automotive vehicle 100, discussed below. The ECU 804 can also be a controller such as the controller 802 discussed above. The ECU 804 can be, or can be in communication with, various other control systems 1314. In some examples, the controller 802 or the ECU 804 can be excluded or replaced by the control systems 1314.

The controller 802 can be connected to various actuators, such as recline actuators 806, fore actuators 808, mid actuators 810, and rear actuators 812, which can be the recline actuators 224, fore actuator 230, middle actuators 232, and aft actuators 234, respectively, discussed above. The controller 802 can also be connected to a user interface 814 and one or more sensors 816, which can be one or more position sensors or the like configured to determine a position of one or more component of the continuous frame 202 or one or more actuators of the seat assembly 200.

The user interface 814 can be any display or input device. For example, user interface can be a monitor, keyboard, and mouse in one example. In other examples, user interface 814 can be a touch screen display. In yet another example, user interface 814 can include lights, buttons, or switches. The controller 802 and user interface 814 can include machine readable medium. The terms “machine readable medium” can include any medium that is capable of storing, encoding, or carrying instructions for execution by the device and that cause the device to perform any one or more of the techniques of the present disclosure, or that is capable of storing, encoding or carrying data structures used by or associated with such instructions. Non-limiting machine readable medium examples can include solid-state memories, and optical and magnetic media. Specific examples of machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In operation of some examples, the controller 802 can receive one or more inputs from the user interface 814 (e.g., from a user or occupant) or the ECU 804, such as to change a position of one or more portions of the continuous frame 202. Based on the input received, the controller 802 can operate one or more of the actuators 806-812 to adjust a position of the continuous frame 202 to achieve the desired position of the occupant. The controller 802 can, in some examples, receive one or more signals from the sensor 816, which can be used as feedback by the controller 802 to achieve the desired position or to confirm that the desired position is achieved. Various examples of different movements are discussed below.

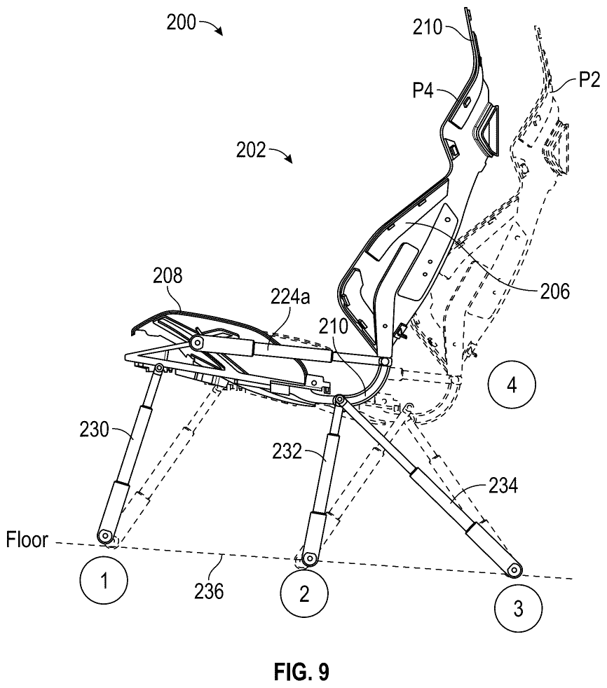

FIG. 9-FIG. 12 illustrate side views of the seat assembly 200 including tables showing how the actuators can operate to move the seat assembly 200, according to some examples. FIG. 9-FIG. 12 are discussed together below. The seat assembly 200 can be consistent with FIG. 1-FIG. 8 discussed above.

FIG. 9 shows the continuous frame 202 in a partially reclined position P2 and shows that the continuous frame 202 can move to a forward position P4 where the continuous frame 202 is moved forward or fore relative to a floor 236. As shown in the first row (Fore) of Table 1 below, to move the continuous frame 202 from the position P2 to the position P4, the fore actuators 230 and the middle actuators 232 can be shortened and the aft actuators 234 can be lengthened while the recline actuators 224 can be held in the previous or current positions. Conversely, to move the continuous frame 202 from the forward position P4 to the partially reclined position P2, the fore actuators 230 and the middle actuators 232 can be lengthened and the aft actuators 234 can be shortened while the recline actuators 224 can be held in the previous or current positions. In this way, the actuators can be controlled (e.g., by the controller 802 via the user interface 814) to move the continuous frame 202 fore and aft relative to the floor 236 and the chassis 102 of the automotive vehicle 100.

TABLE 1

| | Actuator 1 | Actuator 2 | Actuator 3 | Actuator 4 |
|---|---|---|---|---|
| Resultant Seat Motion | Motion | Motion | Motion | Motion |
| Fore | Shorten | Shorten | Lengthen | Hold |
| Aft | Lengthen | Lengthen | Shorten | Hold |
| Height Up | Lengthen | Lengthen | Lengthen | Hold |
| Height Down | Shorten | Shorten | Shorten | Hold |
| Cushion Tilt Up | Lengthen | Hold | Hold | Shorten |
| Cushion Tilt Down | Shorten | Hold | Hold | Lengthen |
| Backrest Rotate Forward | Hold | Hold | Hold | Shorten |
| Backrest Rotate | Hold | Hold | Hold | Lengthen |
| Backward | | | | |

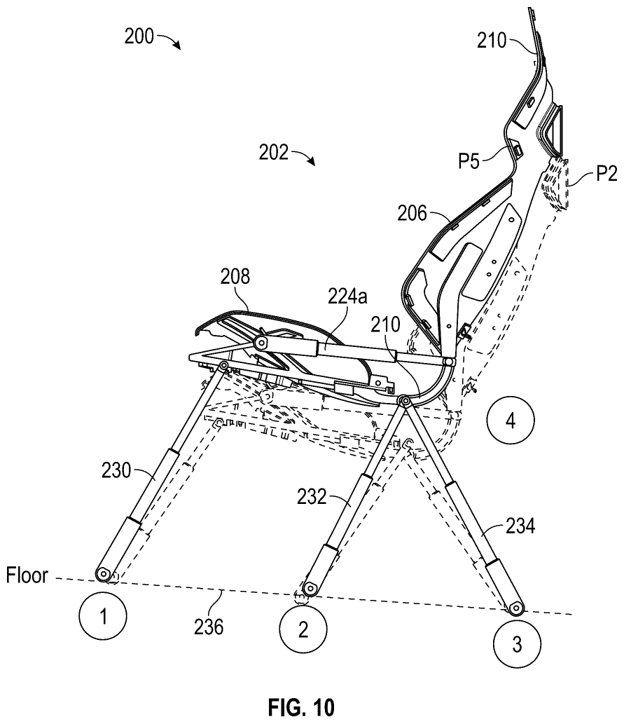

FIG. 10 shows the continuous frame 202 in a partially reclined position P2 and shows that the continuous frame 202 can move to a raised or elevated position P5 where the continuous frame 202 is moved upward relative to the floor 236 (or chassis 102). As shown in the third row (Height Up) of the Table 1 above, to move the continuous frame 202 from the position P2 to the position P5, the fore actuators 230, the middle actuators 232, and the aft actuators 234 can be lengthened and the recline actuators 224 can be held in the previous or current positions. Conversely, to move the continuous frame 202 from the raised position P5 to the partially reclined position P2 (which is lower), the fore actuators 230, the middle actuators 232, and the aft actuators 234 can be shortened while the recline actuators 224 can be held in the previous or current positions. In this way, the actuators can be controlled (e.g., by the controller 802 via the user interface 814) to raise and lower the continuous frame 202 relative to the floor 236 and the chassis 102 of the automotive vehicle 100.

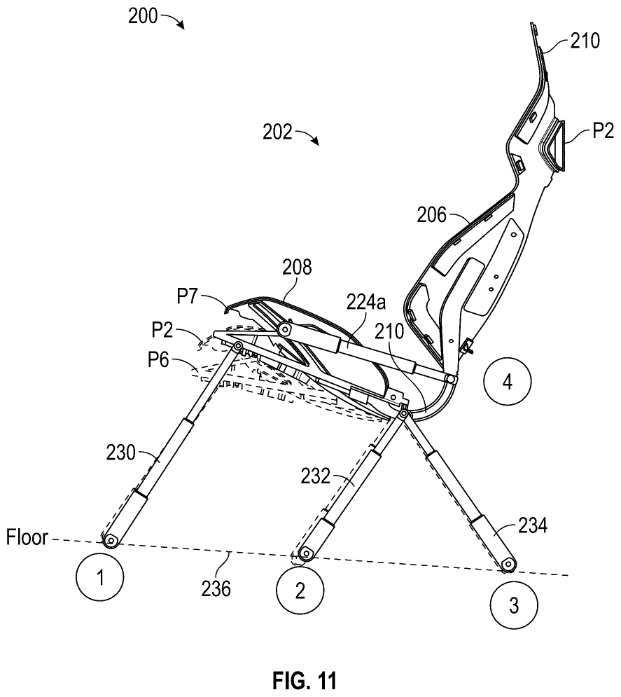

FIG. 11 shows the continuous frame 202 in a partially reclined position P2 and shows that the seat portion 208 can tilt upward or downward with respect to the floor 236 and the chassis 102. As shown in the fifth row (Cushion Tilt Up) of Table 1 above, to move the seat portion 208 from the position P2 to the position P7, which is tilted upward, the fore actuators 230 can be lengthened, the recline actuators 224 can be shortened, and the middle actuators 232 and the aft actuators 234 can be held in the previous or current positions. Conversely, to move the seat portion 208 from the position P2 (or P7) to the position P6, which is tilted downward, the fore actuators 230 can be shortened, the recline actuators 224 can be lengthened, and the middle actuators 232 and the aft actuators 234 can be held in the previous or current positions. In this way, the actuators can be controlled (e.g., by the controller 802 via the user interface 814) to tilt the seat portion 208 relative to the floor 236, relative to the backrest portion 206, and relative to the chassis 102 of the automotive vehicle 100.

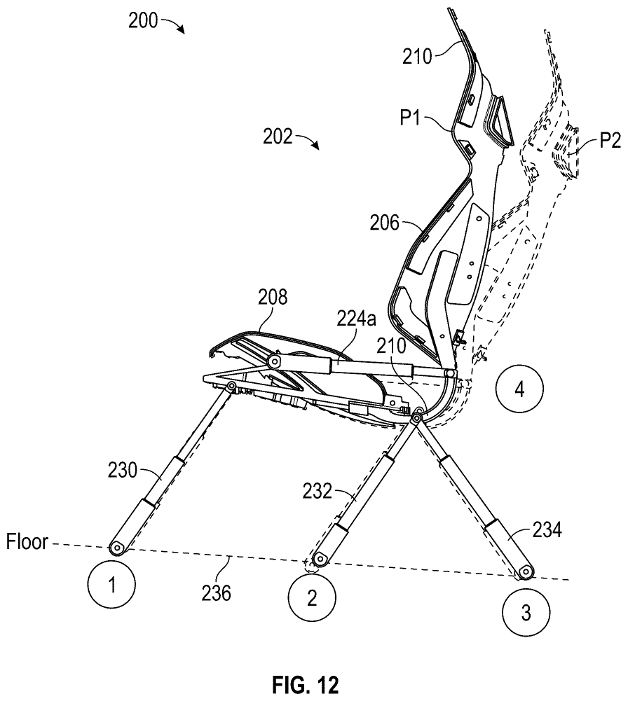

FIG. 12 shows the continuous frame 202 in a partially reclined position P2 and shows that the continuous frame 202 can move to the upright position P1 where the backrest portion 206 is rotated forward or fore relative to the seat portion 208, the floor 236, and the chassis 102. As shown in the seventh row (Backrest Rotate Forward) of Table 1 above, to move the backrest portion 206 from the position P2 to the position P1, the recline actuators 224 can be shortened while the fore actuators 230, the middle actuators 232, and the aft actuators 234 can be held in the previous or current positions. Conversely, to move the backrest portion 206 from the position P1 to the position P2, the recline actuators 224 can be lengthened while the fore actuators 230, the middle actuators 232, and the aft actuators 234 can be held in the previous or current positions. In this way, the actuators can be controlled (e.g., by the controller 802 via the user interface 814) to rotate the backrest portion 206 relative to the seat portion 208, to the floor 236, and to the chassis 102 of the automotive vehicle 100.

Though FIG. 7 though FIG. 12 discuss the use of powered actuators (e.g., including a controller) that are controlled (e.g., via the controller 802) to move, one or more of the actuators can be a manual actuator that can operated by hand or otherwise by a user or occupant to adjust the continuous frame 202 into a desired position. For example, a user can unlock one or more of the actuators, adjust a position of the continuous frame 202, and then re-lock the actuators into the desired position of the continuous frame 202. The manual actuators can be any linear extending and locking mechanism or manual actuator.

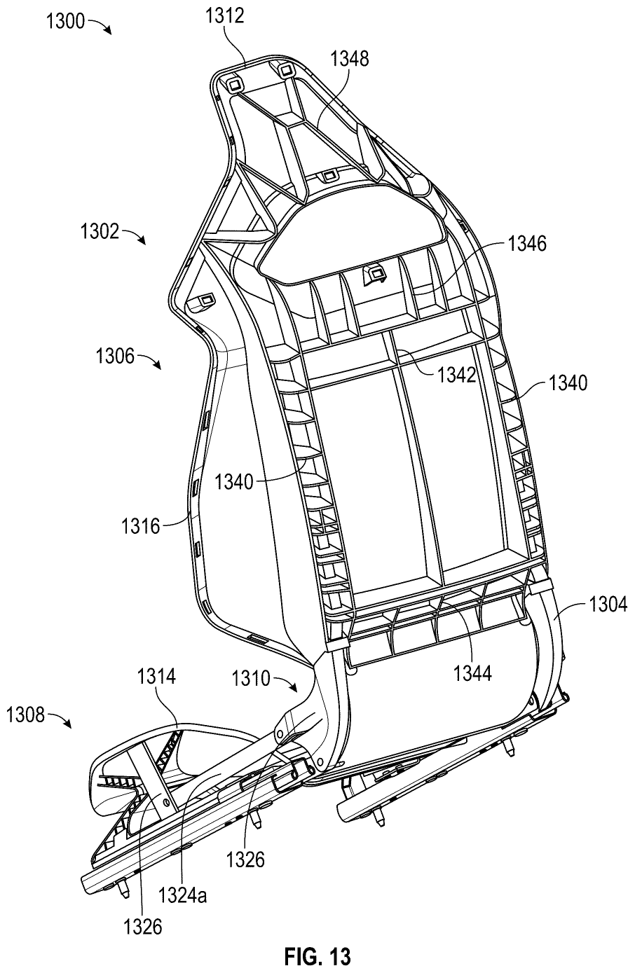

FIG. 13 illustrates an isometric view of a seat assembly 1300 for an automotive vehicle (e.g., the automotive vehicle 100), according to some examples. The seat assembly 1300 can be similar to the seat assembly 200 discussed above. The seat assembly 1300 includes support ribs that can be integral to the seat assembly 1300. Any of the seat assemblies discussed above or below can include the features of the seat assembly 1300.

The seat assembly 1300 can include a continuous frame 1302, which can be a rigid or semi-rigid frame that can be secured to a frame 1304 or rails (that can be secured to the chassis 102) such as to secure the continuous frame 1302 to the chassis 102 of the automotive vehicle 100. The continuous frame 1302 can include a backrest portion 1306, a seat portion 1308, a hinge portion 1310, and a headrest portion 1312. The seat portion 1308 can be connected to a lower portion of the backrest portion 1306 by the hinge portion 1310, and the headrest portion 1312 can be connected to an upper portion of the backrest portion 1306. The hinge portion 1310 can be configured to flex to allow relative movement of the backrest portion 1306 with respect to the seat portion 1308, such as reclining, tilting, pivoting, or otherwise moving.

One or more of the backrest portion 1306, the seat portion 1308, the hinge portion 1310, and the headrest portion 1312 can be formed as a continuous frame such that the 1302 is monolithic or a single continuous component. Optionally, one or more of the backrest portion 1306, the seat portion 1308, the hinge portion 1310, and the headrest portion 1312 can be separately formed and connected to the continuous frame 1302. For example, the headrest portion 1312 can be separately formed and connected to the backrest portion 1306.

The continuous frame 1302 can be made of a composite, such as an anisotropic composite that can be molded to a desired shape, such as via thermoforming, to form a monolithic composite structure. For example, the continuous frame 1302 can be made of a fiberglass-nylon composite, a fiberglass-polymer composite, a nylon carbon composite, a Kevlar-nylon composite, a Kevlar-polymer composite, or the like. The continuous frame 1302 can be made of multiple plies or layers to achieve a desired strength where the plies (or thicknesses thereof) can vary in different areas or portions of the continuous frame 1302. The molded composite of the continuous frame 1302 can be overmolded by one or more polymers or polymer composites to add one or more features such as clips, hooks, protrusions (e.g., aesthetic or comfort features), fasteners, supports, or the like. Through the design and manufacturing process, stiffness of the backrest portion 1306, the seat portion 1308, and the hinge portion 1310 can be tuned to provide different performance in different portions of the continuous frame 1302.

The backrest portion 1306 can include one or more backrest bolster 1316 (e.g., backrest bolsters 1316) that can be connected to opposite lateral sides of the 1306. Each of the backrest bolsters 1316 can extend at least partially fore or forward of the backrest portion 1306. The backrest portion 1306 and the backrest bolsters 1316 can, together or independently, be configured to support a posterior and lateral portion of a torso, arms, or head of a user, operator, or passenger of the automotive vehicle 100. The backrest bolsters 1316 can be formed, together with one or more of the backrest portion 1306, the seat portion 1308, the hinge portion 1310, and the headrest portion 1312 as a single continuous component.

Similarly, the seat portion 1308 can include one or more seat bolster 1314 (e.g., seat bolsters 1314) that can be connected to opposite lateral sides of the seat portion 1308. The seat bolsters 1314 can be seat bolsters or cushions extending from the seat portion 1308. The seat bolsters 1314 can be located or positioned on opposing sides of the seat portion 1308. The seat bolsters 1314 can be laterally located or positioned relative to the continuous frame 1302 and the seat bolsters 1314 can each extend upward such that the seat bolsters 1314 are configured to provide lateral upper leg support, such as during turning of the automotive vehicle 100. Together or independently, the seat bolsters 1314 can be configured to support the lower portion, e.g., below a waist, such as the posterior and lateral portions of the upper legs of a user, operator, or passenger of the automotive vehicle 100. The seat bolsters 1314 can be formed, together with one or more of the backrest portion 1306, the seat portion 1308, the hinge portion 1310, and the headrest portion 1312 as a single continuous component.

The continuous frame 1302 can be configured to flex and move, such as for increasing comfort and ergonomics of the continuous frame 1302. The hinge portion 1310 can be configured to flex to allow such movement or adjustment of the continuous frame 1302. In some examples, the hinge portion 1310 can include multiple sections with varying flexibility to help increase a range of movement and flexibility of the continuous frame 1302, similar to the stiffness regions of the continuous frame 202 discussed above.

The seat assembly 1300 can also include one or more recline actuators recline actuator 1324, which can be a linear actuator, motor, or the like. The recline actuators 1324 can be connected to respective lateral sides of the continuous frame 1302. For example, the recline actuator 1324a can connect to the continuous frame 1302 at a top portion of the hinge portion 1310 or a bottom portion of the backrest portion 1306 or at a location where the hinge portion 1310 and the backrest portion 1306 meet or connect. The recline actuator 1324a can also connect to the seat portion 1308, such as to a front or fore portion thereof. The recline actuators 1324 can be connected to the continuous frame 1302 by joints joint 1326, which can be bearings, pivots, or the like, configured to allow for rotation of the recline actuators 1324 with respect to the continuous frame 1302. The recline actuators 1324 can operate similarly to the recline actuators 224 discussed above. The recline actuators 1324 can be mounted or connected to the hinge portion 1310 and the seat portion 1308 low relative to the recline actuators 224, which can help to provide more clearance or space for components of the seat assembly 1300, such as electronics, switches, comfort materials (e.g., foam), or the like.

FIG. 13 also shows that the backrest portion 1306 can include ribs, such as lateral ribs 1340, center ribs 1342, lower ribs 1344, and upper ribs 1346. The lateral ribs 1340 can be connected to a rear portion of the backrest portion 1306 at either or both laterally outward portions of the backrest portion 1306. The center ribs 1342 can be connected to a rear portion of the backrest portion 1306 and can be located in a center portion of the backrest portion 1306. The lower ribs 1344 can be connected to a rear portion of the backrest portion 1306 and can be located in a lower portion of the backrest portion 1306, such as near the hinge portion 1310 or the seat portion 1308. The backrest portion 1306 can be connected to a rear portion of the backrest portion 1306 and can be located in an upper portion of the backrest portion 1306, such as near the headrest portion 1312 FIG. 13 also shows that the headrest portion 1312 can include headrest ribs 1348 connected to a rear portion of the headrest ribs 1348.

The various ribs discussed above can be integrated into, or integrally formed with, the backrest portion 1306 (or the headrest portion 1312) and the seat assembly 1300 and can be configured to provide reinforcement and stiffness of the seat assembly 1300. For example, the ribs can be strategically located to reinforce t certain portions of the backrest portion 1306 or the headrest portion 1312 to achieve a desired regional stiffness. Each set of ribs can include vertical ribs, horizontal ribs, diagonal ribs, or the like, which can be selected to achieve a desired stiffness or desired regional stiffness or flexibility.

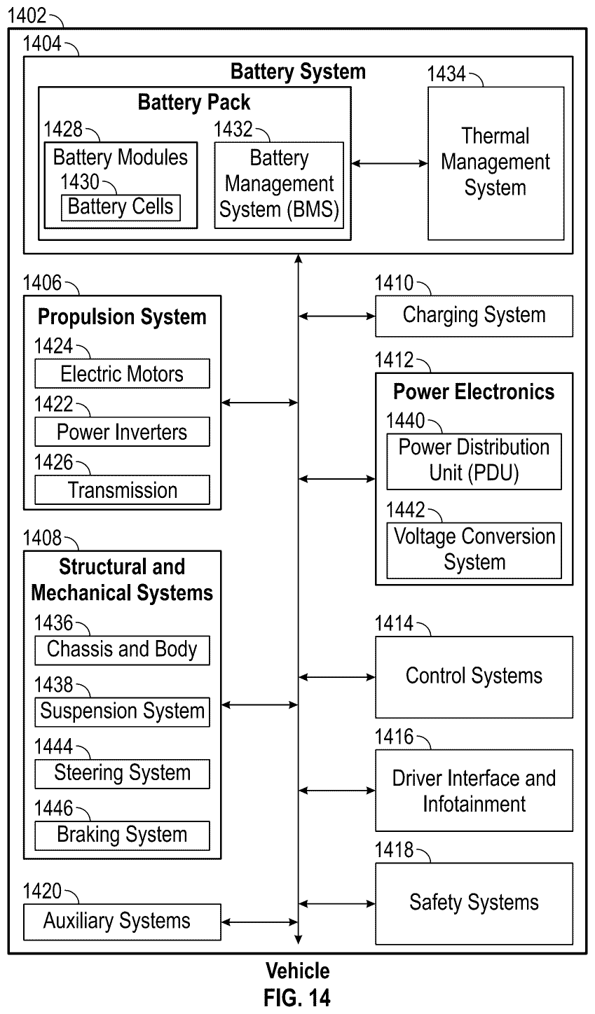

FIG. 14 is a system diagram illustrating an architecture of an electric vehicle (EV) 1402, according to some examples. This diagram shows systems and sub-systems that can collectively enable the functionality and operational efficiency of the electric vehicle 10.

The vehicle 1402 (which can be the automotive vehicle 100) can include a number of higher-level systems which are interconnected, including a battery system 1404, a propulsion system 1406, structural and mechanical systems 1408, a charging system 1410, power electronics 1412, control systems 1414, driver interface and infotainment 1416, safety systems 1418, and auxiliary systems 1420.

The propulsion system 1422 includes one or more electric motors 14, which can include traction motors for propulsion and motors for regenerative braking systems, convert electrical energy into mechanical energy. Power inverters 1424, facilitate the conversion of DC power from the battery to AC power required by the electric motors 1426. The propulsion system also includes a transmission 1428, which can consist of a single-speed transmission or gearbox, channeling mechanical power to the vehicle's wheels.

The battery system 1404 is composed of several battery modules 1430, each housing multiple battery cells 1432. These battery cells 1432 can be based on various chemistries, including lithium-ion, lithium-polymer, or solid-state materials, each offering distinct advantages in terms of energy density, recharge cycles, and safety profiles.

A battery management system (BMS) 1434 continuously monitors various parameters, such as voltage, current, and temperature of each of the battery cells 1432 and battery modules 1430, to prevent conditions that could lead to overcharging, deep discharging, or thermal runaway. The battery management system (BMS) 1434 also manages the state of charge (SoC) and state of health (SoH) of the battery, ensuring that the energy is distributed during discharge and that the charging process is optimized for longevity and safety. Each battery management system (BMS) 1434 employs algorithms to balance the charge across the cells and modules, correcting imbalances that can reduce the battery's overall capacity and lifespan.

Integrated with the battery system 1404 is a thermal management system 1436, which operatively maintains the battery cells 1432 within specified temperature ranges. The thermal management system 1436 employs temperature sensors to monitor the heat generated by the battery cells 1432 during operation. Based on the data collected, it activates cooling and heating mechanisms to regulate the battery's temperature. Cooling methods can include air cooling, where ambient air is circulated around the battery modules, or liquid cooling, where a coolant is circulated through channels in or around the battery modules to absorb and dissipate heat. In colder environments, the thermal management system 1436 can employ heating elements or use waste heat from the vehicle's systems to warm the battery cells, ensuring they operate efficiently even in low temperatures.

The charging system 1410 operatively replenishes the stored energy within the battery system 1404 of the electric vehicle 1402. It supports various charging methodologies to ensure flexibility and convenience in energy restoration. The charging system 1410 can encompass systems for both standard (Level 1 and Level 2) and fast charging (DC fast charging), facilitating a range of charging speeds to suit different user needs and infrastructure capabilities.

For standard charging, the charging system 1410 includes an onboard charger for AC/DC conversion. This onboard charger converts the alternating current (AC) from the electrical grid or home outlets into direct current (DC) that can be stored in the vehicle's battery system 1404. The onboard charger may, for example support Level 1 and Level 2 charging, with Level 1 charging using standard household outlets (1408-120V) and Level 2 charging requiring a higher voltage source (208-240V), such as those found in dedicated charging stations or installed in residential garages.

For fast charging, the charging system 1410 can incorporate a DC fast charging system, designed for rapid energy transfer directly to the vehicle's battery system 1404, bypassing the onboard charger. DC fast charging stations supply high-voltage (e.g., 400V to 800V) direct current directly to the battery system 1404.

Additionally, the electric vehicle 1402 can be equipped with an auxiliary battery, such as a 12V lead-acid or lithium-ion battery can be tasked with powering the vehicle's low-voltage systems, including lighting, infotainment, electronic control units, and other ancillary components, ensuring their operation even when the main battery system is off or during the initial stages of charging when the main system's voltage might be too low for these tasks. This separation of power sources enhances the vehicle's electrical system reliability and ensures the availability of essential functions.

Structural and mechanical systems 1408, including a chassis and body 1438 and suspension system 1440, provide the physical framework and support for the vehicle 1402. The chassis and body 1438 constitute the vehicle's primary structure, while the suspension system 1440, which can include springs, shock absorbers (or dampers), and control arms, to provide a smooth and stable ride by mitigating road shocks and vibrations.

Power electronics 1412, including a power distribution unit (PDU) 1442 and a voltage conversion system 1444, are responsible for the management and conversion of electrical power within the vehicle. The power distribution unit (PDU) 1442, equipped with fuses and relays, distributes power to various vehicle systems, while voltage conversion devices of the voltage conversion system 1444, such as DC/DC and AC/DC converters, adjust the voltage levels to meet the specific requirements of different components.

Control systems 1414 facilitate the driver's command over the vehicle, with a steering system 1446 and a braking system 1448 as examples. The steering system 1446, including a power steering motor, allows for precise directional control, whereas the braking system 1448, which can feature disc brakes and an anti-lock braking system (ABS), enables deceleration and stopping.

The driver interface and infotainment 1416 supports the driving experience by providing vehicle information and entertainment options through digital displays and multimedia systems. Connectivity features, such as Bluetooth and USB, further augment functionality.

Safety systems 1418, designed to protect the vehicle's occupants, can include airbag systems and advanced driver-assistance systems (ADAS), for example. ADAS can use an array of sensors, cameras, radar, LiDAR, or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver performs all driving tasks, to Level 5, which represents full automation with no human intervention required under any circumstances. Levels 1 and 2 focus on driver assistance and partial automation, respectively, where systems such as adaptive cruise control, lane-keeping assistance, and automatic emergency braking support the driver but do not replace them. Level 3, conditional automation, allows the vehicle to handle all aspects of driving in certain conditions, but requires the driver to be ready to take control when needed. Level 4, high automation, enables the vehicle to operate independently in most scenarios, though human override is still possible.

Examples of ADAS that contribute to these levels of automation include, but are not limited to, adaptive cruise control, which adjusts the vehicle's speed to maintain a safe distance from vehicles ahead; lane departure warning systems, which alert the driver when the vehicle begins to drift out of its lane; and automatic parking systems, which assist or take over control of the vehicle during parking maneuvers. More advanced systems, contributing to higher levels of automation, involve complex algorithms and machine learning capabilities to interpret sensor data, predict actions of other road users, and make real-time driving decisions.

Auxiliary systems 1420 support the vehicle's functions and occupant comfort, with climate control and lighting systems as examples. The auxiliary systems 1420 can also include windshield wipers etc.

As noted above, the systems of the 1402 are communicatively connected. Communications between the interconnected systems within vehicle 1402 are facilitated through a vehicle network architecture, employing both hardware and software components to ensure seamless data exchange and coordination. This network architecture can include one or more vehicle communication buses, such as for example Controller Area Network (CAN), Local Interconnect Network (LIN), FlexRay, and Ethernet, which serve as the backbone for intra-vehicle communications.

The Controller Area Network (CAN) bus is a vehicle bus standard designed to allow microcontrollers and devices to communicate with each other within the vehicle 1402 without a host computer. Such a network can support control communications between systems such as the battery system 1404, propulsion system 1406, and control systems 1414, due to its high reliability and resistance to interference. A CAN bus can support messages that ensure real-time control and monitoring of these systems.

For other communications, such as those involving the driver interface and infotainment 1416 or auxiliary systems 1420, a Local Interconnect Network (LIN) bus can be employed. LIN can provide a cost-effective, low-speed serial communication system for connecting intelligent sensors and actuaries. It can serve as a sub-network to the CAN bus, handling signals such as switch inputs and actuator outputs.

FlexRay technology offers a higher data rate compared to CAN and LIN, providing the necessary bandwidth for advanced control systems, including those required for autonomous driving functionalities within safety systems 1418. Its deterministic nature and fault tolerance make it suitable for applications that require precise timing and synchronization, such as coordinating the actions of multiple control units in real-time.

Ethernet, with its high data transfer rate, can for example be adopted for diagnostics and infotainment applications within the vehicle 1402. It supports the rapid transfer of large volumes of data, making it well suited for advanced driver assistance systems (ADAS), software updates, and multimedia streaming in the driver interface and infotainment 1416 system.

Software protocols and application programming interfaces (APIs) built on top of these physical layers enable high-level communication and data exchange between systems. These protocols can define the rules for data format, timing, and error handling, ensuring that messages are correctly interpreted and acted upon by the receiving systems.

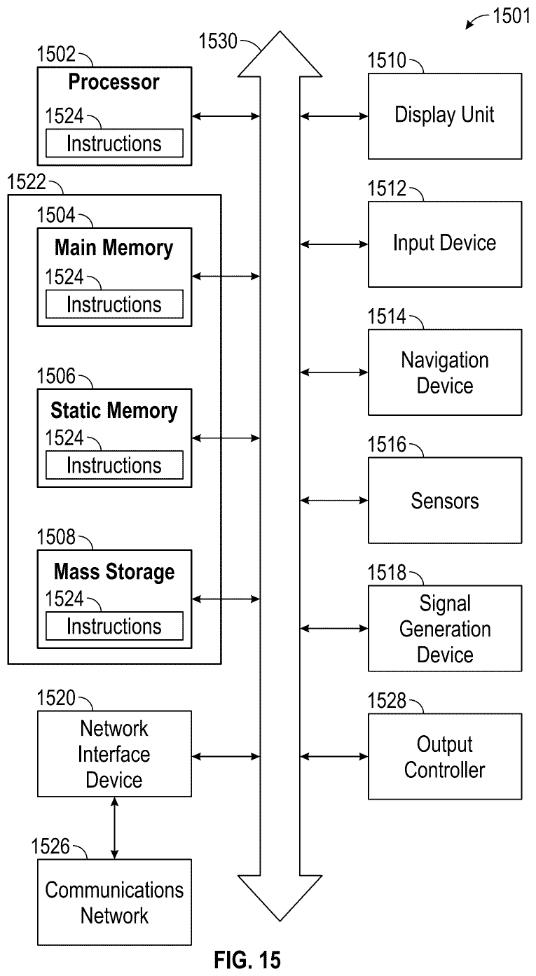

FIG. 15 illustrates a block diagram of an example machine 1500 upon which any one or more of the techniques (e.g., methodologies) discussed herein can perform, according to some examples. Examples, as described herein, can include, or can operate by, logic or a number of components, or mechanisms in the machine 1500. Circuitry (e.g., processing circuitry) is a collection of circuits implemented in tangible entities of the machine 1500 that include hardware (e.g., simple circuits, gates, logic, etc.). Circuitry membership can be flexible over time. Circuitries include members that may, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 1500 follow.

In alternative examples, the machine 1500 can operate as a standalone device or can be connected (e.g., networked) to other machines. In a networked deployment, the machine 1500 can operate in the capacity of a server machine, a client machine, or both in server-client network environments. In an example, the machine 150000 can act as a peer machine in peer-to-peer (P2P) (or other distributed) network environment. The machine 150000 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1500 can include a hardware processor 1502 (e.g., a central processing unit (CPU), a graphics processing unit (GPU), a hardware processor core, or any combination thereof), a main memory 1504, a static memory (e.g., memory or storage for firmware, microcode, a basic-input-output (BIOS), and mass storage 1508 (e.g., hard drives, tape drives, flash storage, or other block devices) some or all of which can communicate with each other via an interlink 1430 (e.g., bus). The machine 1500 can further include a display unit 1510, an alphanumeric input device 1512 (e.g., a keyboard), and a user interface (UI) navigation device 1514 (e.g., a mouse). In examples, the display unit 1510, input device 1512 and UI navigation device 1514 can be a touch screen display. The machine 1500 can additionally include a signal generation device 1518 (e.g., a speaker), a network interface device 1520, and one or more sensors 1516, such as a global positioning system (GPS) sensor, compass, accelerometer, or other sensor. The machine 1500 can include an output controller 1528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1502, the main memory 1504, the static memory 1506, or the mass storage 1508 can be, or include, a machine-readable medium 1522 on which is stored one or more sets of data structures or instructions 1524 (e.g., software) embodying or utilized by any one or more of the techniques or functions described herein. The instructions 1524 can also reside, completely or at least partially, within any of registers of the processor 1502, the main memory 1504, the static memory 1506, or the mass storage 1508 during execution thereof by the machine 1500. In an example, one or any combination of the hardware processor 1502, the main memory 1504, the static memory 1506, or the mass storage 1508 can constitute the machine-readable media machine-readable medium 1522. While the machine-readable medium 1522 is illustrated as a single medium, the term “machine-readable medium” can include a single medium or multiple media (e.g., a centralized or distributed database, or associated caches and servers) configured to store the one or more instructions 1524.

The term “machine-readable medium” can include any medium that is capable of storing, encoding, or carrying instructions for execution by the machine 1500 and that cause the machine 1500 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine-readable media that do not include transitory propagating signals. Specific examples of non-transitory machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine-readable medium 1522 can be representative of the instructions 1524, such as instructions 1524 themselves or a format from which the instructions 1524 can be derived. This format from which the instructions 1524 can be derived can include source code, encoded instructions (e.g., in compressed or encrypted form), packaged instructions (e.g., split into multiple packages), or the like. The information representative of the instructions 1524 in the machine-readable medium 1522 can be processed by processing circuitry into the instructions to implement any of the operations discussed herein. For example, deriving the instructions 1524 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1524.

In an example, the derivation of the instructions 1524 can include assembly, compilation, or interpretation of the information (e.g., by the processing circuitry) to create the instructions 1524 from some intermediate or preprocessed format provided by the machine-readable medium 1522. The information, when provided in multiple parts, can be combined, unpacked, and modified to create the instructions 1524. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1524 can be further transmitted or received over a communications network 1526 using a transmission medium via the network interface device 1520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 1102.11 family of standards known as Wi-Fi®, IEEE 1102.15.4 family of standards, peer-to-peer (P2P) networks, among others. In an example, the network interface device 1520 can include one or more physical jacks (e.g., Ethernet, coaxial, or phone jacks) or one or more antennas to connect to the communications network 1526. In an example, the network interface device 1520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1500, and includes digital or analog communications signals or other intangible medium to facilitate communication of such software. A transmission medium is a machine-readable medium.

### NOTES AND EXAMPLES

The following, non-limiting examples, detail certain aspects of the present subject matter to solve the challenges and provide the benefits discussed herein, among others.

Example 1 is a seat assembly for an automotive vehicle, comprising: a continuous frame securable to a chassis of the automotive vehicle, the continuous frame comprising: a seat portion; a backrest portion; and a hinge connected to the seat portion and the backrest portion, the hinge configured to flex to allow relative movement of the backrest portion with respect to the seat portion.

In Example 2, the subject matter of Example 1, in some examples, includes wherein the seat portion, the backrest portion, and the hinge are formed as a single continuous component.

In Example 3, the subject matter of Example 2, in some examples, includes a headrest portion connected to a top of the backrest portion, the headrest portion formed, together with the seat portion, the backrest portion, and the hinge as a single continuous component.

In Example 4, the subject matter of Example 3, in some examples, includes a pair of bolster portions connected to laterally opposite sides of the backrest portion below the headrest portion, the pair of bolster portions formed, together with the headrest portion, the seat portion, the backrest portion, and the hinge as a single continuous component.

In Example 5, the subject matter of any one or more of Examples 1-4, in some examples, include wherein the seat portion is securable to the chassis of the automotive vehicle, and wherein the hinge is configured to flex to allow the backrest portion to move with respect to the seat portion to adjust an angle of the backrest portion.

In Example 6, the subject matter of any one or more of Examples 1-5, in some examples, include wherein the hinge comprises: a central portion integrally formed with the backrest portion and the seat portion; and one or more linkage assemblies connected to the central portion and configured to support the central portion when the hinge flexes to allow the relative movement of the backrest portion with respect to the seat portion.

In Example 7, the subject matter of Example 6, in some examples, includes wherein the one or more linkage assemblies includes: a first linkage assembly connected to a first lateral side of the central portion; and a second linkage assembly connected to a first lateral side of the central portion.

In Example 8, the subject matter of Example 7, in some examples, includes wherein one or more of the first linkage assembly and the second linkage assembly includes a plurality of links including gears, the plurality of links engaged with adjacent links via the gears.

In Example 9, the subject matter of Example 8, in some examples, includes when the plurality of links of one or more of the first linkage assembly and the second linkage assembly includes a first link connected to the seat portion or the hinge and a second link connected to the backrest portion or the hinge to connect the plurality of links to the seat portion and the backrest portion, respectively.

In Example 10, the subject matter of Example 9, in some examples, includes wherein the first link is at least partially integrally formed into the hinge or the seat portion and the second link is at least partially integrally formed into the hinge or the backrest portion.

Example 11 is a seat assembly for an automotive vehicle, comprising: a continuous frame securable to a chassis of the automotive vehicle, the continuous frame comprising: a seat portion; a backrest portion; and a hinge connected to the seat portion and the backrest portion, the hinge configured to flex to allow relative movement of the backrest portion with respect to the seat portion.

In Example 12, the subject matter of Example 11, in some examples, includes a headrest portion connected to a top of the backrest portion, the headrest portion formed, together with the seat portion, the backrest portion, and the hinge as a single continuous component.

In Example 13, the subject matter of Example 12, in some examples, includes wherein the headrest portion and the backrest portion together define a recess configured to receive a soft trim component at least partially therein to secure the soft trim component to the continuous frame.

In Example 14, the subject matter of any one or more of Examples 12-13, in some examples, include a pair of bolster portions connected to laterally opposite sides of the backrest portion below the headrest portion, the pair of bolster portions formed, together with the headrest portion, the seat portion, the backrest portion, and the hinge as a single continuous component.

In Example 15, the subject matter of Example 14, in some examples, includes wherein the pair of bolster portions includes a left bolster portion and a right bolster portion located opposite the left bolster portion, wherein the right bolster portion is engageable with a right bolster airbag when deployed to define a right bolster airbag deployment trajectory, and wherein the left bolster portion is engageable with a left bolster airbag when deployed to define a left bolster airbag deployment trajectory.

In Example 16, the subject matter of any one or more of Examples 11-15, in some examples, include wherein the backrest portion includes one or more ventilation holes formed into the backrest portion, the one or more ventilation holes configured to receive airflow into the continuous frame or deliver airflow from the continuous frame.

In Example 17, the subject matter of any one or more of Examples 11-16, in some examples, include wherein the seat portion has a first stiffness and the backrest portion has a second stiffness that is different from the first stiffness.

In Example 18, the subject matter of Example 17, in some examples, includes wherein the hinge has a third stiffness that is different from the first stiffness and the second stiffness.

In Example 19, the subject matter of Example 18, in some examples, includes a headrest portion connected to a top of the backrest portion, the headrest portion formed together with the seat portion, the backrest portion, and the hinge as a single continuous component, the headrest portion having a fourth stiffness that is different from the first stiffness, the second stiffness, and the third stiffness.

In Example 20, the subject matter of Example 19, in some examples, includes a pair of bolster portions connected to laterally opposite sides of the backrest portion below the headrest portion, the pair of bolster portions formed, together with the headrest portion, the seat portion, the backrest portion, and the hinge as a single continuous component, the pair of bolster portions having a fifth stiffness that is different from the first stiffness, the second stiffness, the third stiffness, and the fourth stiffness.

In Example 21, the subject matter of any one or more of Examples 11-20, in some examples, include wherein the continuous frame is made of a glass nylon composite.

Example 22 is a seat assembly for an automotive vehicle, comprising: a continuous frame securable to a chassis of the automotive vehicle, the continuous frame comprising: a seat portion; a backrest portion; and a hinge connected to the seat portion and the backrest portion, the hinge configured to flex to allow relative movement of the backrest portion with respect to the seat portion, the hinge defining an effective axis about which the backrest portion is configured to pivot or move with respect to the seat portion.

In Example 23, the subject matter of Example 22, in some examples, includes an actuator connected to the seat portion and connected to the hinge or the backrest portion, the actuator operable to move the backrest portion with respect to the seat portion.

In Example 24, the subject matter of Example 23, in some examples, includes wherein the actuator is configured to limit movement of the backrest portion with respect to the seat portion when the actuator is not activated.

In Example 25, the subject matter of any one or more of Examples 23-24, in some examples, include wherein the actuator is operable to move the backrest portion relative to the seat portion about the effective axis of the hinge.

In Example 26, the subject matter of any one or more of Examples 22-25, in some examples, include a first recline actuator connected to a first lateral side of the seat portion and connected to a first lateral side of the hinge or the backrest portion; and a second recline actuator connected to a second lateral side of the seat portion and connected to a second lateral side of the hinge or the backrest portion, the first recline actuator and the second recline actuator together operable to move the backrest portion with respect to the seat portion between an upright position and a recline position.

In Example 27, the subject matter of any one or more of Examples 25-26, in some examples, include wherein the seat portion, the backrest portion, and the hinge are formed as a single continuous component.

In Example 28, the subject matter of Example 27, in some examples, includes wherein the seat portion, the backrest portion, and the hinge are configured to locate the effective axis within the hinge to enable the backrest portion to pivot or rotate about the effective axis ergonomically.

In Example 29, the subject matter of any one or more of Examples 27-28, in some examples, include a headrest portion connected to a top of the backrest portion; and a pair of bolster portions connected to laterally opposite sides of the backrest portion below the headrest portion, the pair of bolster portions formed, together with the headrest portion, the seat portion, the backrest portion, and the hinge as a single continuous component.

Example 30 is a seat assembly for an automotive vehicle, comprising: a continuous frame securable to a chassis of the automotive vehicle, the continuous frame comprising: a seat portion; a backrest portion; and a hinge connected to the seat portion and the backrest portion, the hinge configured to flex to allow relative movement of the backrest portion with respect to the seat portion; a fore actuator connected to the chassis and the seat portion; a middle actuator connected to the chassis and the seat portion or the hinge; and an aft actuator connected to the chassis and the seat portion or the hinge, the fore actuator, the middle actuator, and the aft actuator together operable to move the continuous frame fore and aft relative to the chassis.

In Example 31, the subject matter of Example 30, in some examples, includes wherein the fore actuator, the middle actuator, and the aft actuator are together operable to raise and lower the continuous frame relative to the chassis.

In Example 32, the subject matter of Example 31, in some examples, includes wherein the fore actuator is operable to tilt the seat portion up and down relative to the chassis, the hinge configured to flex to enable the seat portion to tilt.

In Example 33, the subject matter of any one or more of Examples 30-32, in some examples, include a recline actuator connected to the seat portion and connected to the hinge or the backrest portion, the recline actuator operable to move the backrest portion with respect to the seat portion.

In Example 34, the subject matter of Example 33, in some examples, includes wherein the recline actuator is configured to limit movement of the backrest portion with respect to the seat portion when the recline actuator is not activated.

In Example 35, the subject matter of any one or more of Examples 30-34, in some examples, include a controller connected to the fore actuator, the middle actuator, and the aft actuator, the controller configured to control the fore actuator, the middle actuator, and the aft actuator to: move the continuous frame fore and aft relative to the chassis; raise and lower the continuous frame relative to the chassis; and tilt the seat portion up and down relative to the chassis.

In Example 36, the subject matter of Example 35, in some examples, includes a recline actuator connected to the seat portion and connected to the hinge or the backrest portion, the recline actuator, the recline actuator connected to the controller, and the controller configured to operate the recline actuator to move the backrest portion with respect to the seat portion.

Example 37 is a method of manufacturing a continuous frame for a seat assembly, the method comprising: thermoforming an insert made of multiple plies of nylon carbon composite; overmolding the insert with a polymer or polymer composite to form a continuous frame, the continuous frame including: a seat portion; a backrest portion; and a hinge connected to the seat portion and the backrest portion, the hinge configured to flex to allow relative movement of the backrest portion with respect to the seat portion.

Example 38 is a seat support structure for a vehicle seat, comprising: a single continuous structure configured to provide support for both a seat cushion and a backrest region of the vehicle seat; a functional hinge integrated within the single continuous structure, wherein the functional hinge is configured to flex and provide backrest angle adjustment.

In Example 39, the subject matter of Example 38, in some examples, includes wherein the functional hinge is implemented as a fiber composite leaf spring.

In Example 40, the subject matter of any one or more of Examples 38-39, in some examples, include wherein the functional hinge is implemented as an assembly of rigid linkages.

In Example 41, the subject matter of any one or more of Examples 38-40, in some examples, include wherein the functional hinge provides an ergonomic recline axis that is near a lower extremity of the functional hinge to match a virtual recline axis of a human skeletal structure.

In Example 42, the subject matter of any one or more of Examples 38-41, in some examples, include wherein the functional hinge is configured to fold forward to enable a compact stowed position of the vehicle seat.

In Example 43, the subject matter of any one or more of Examples 38-42, in some examples, include wherein the single continuous structure is manufactured as one part, thereby reducing a number of parts and assembly steps required for the vehicle seat.

Example 44 is a vehicle seat comprising: a support structure as recited in any one of Examples 38-43; a cushion and a backrest supported by the single continuous structure; an actuator system configured to adjust a position of the vehicle seat by interacting with the functional hinge.

In Example 45, the subject matter of Example 44, in some examples, includes wherein the actuator system comprises a plurality of linear actuators configured to adjust fore and aft position, height, cushion tilt, and backrest angle of the vehicle seat.

In Example 46, the subject matter of any one or more of Examples 44-45, in some examples, include wherein the support structure further comprises zones of varying stiffness to provide differentiated support and comfort to an occupant.

In Example 47, the subject matter of any one or more of Examples 44-46, in some examples, include wherein the support structure further comprises an air channel for ventilation and a guide plane for directing airbag deployment trajectory.

Example 48 is a method of adjusting a vehicle seat, the method comprising: providing a seat support structure as recited in any one of Examples 38-43; actuating a functional hinge within the seat support structure to adjust a backrest angle; maintaining an uninterrupted comfort support surface during the backrest angle adjustment.

In Example 49, the subject matter of Example 48, in some examples, includes wherein the actuating step includes folding the functional hinge forward to enable rear seat access in a compact cabin configuration.

In Example 50, the subject matter of any one or more of Examples 48-49, in some examples, include wherein the actuating step includes using a plurality of linear actuators to adjust fore and aft position, height, cushion tilt, and backrest angle of the vehicle seat.

Example 51 is a vehicle seat manufacturing process, comprising: forming a single continuous structure configured to support both a seat cushion and a backrest region of a vehicle seat; integrating a functional hinge within the single continuous structure to provide backrest angle adjustment; reducing a number of parts and assembly steps by manufacturing the single continuous structure as one part.

In Example 52, the subject matter of Example 51, in some examples, includes wherein the functional hinge is formed as a fiber composite leaf spring or as an assembly of rigid linkages.

In Example 53, the apparatuses or method of any one or any combination of Examples 1-52 can, in some examples, be configured such that all elements or options recited are available to use or select from.

The above detailed description includes references to the accompanying drawings, which form a part of the detailed description. The drawings show, by way of illustration, specific examples that can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) can be used in combination with each other. Other examples can be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A seat assembly for an automotive vehicle, comprising:
a continuous frame securable to a chassis of the automotive vehicle, the continuous frame comprising:
a seat portion;
a backrest portion; and
a hinge connected to the seat portion and the backrest portion, the hinge configured to flex to allow relative movement of the backrest portion with respect to the seat portion.

2. The seat assembly of claim 1, wherein the seat portion, the backrest portion, and the hinge are formed as a single continuous component.

3. The seat assembly of claim 2, comprising:
a headrest portion connected to a top of the backrest portion, the headrest portion formed, together with the seat portion, the backrest portion, and the hinge as a single continuous component.

4. The seat assembly of claim 3, comprising:
a pair of bolster portions connected to laterally opposite sides of the backrest portion below the headrest portion, the pair of bolster portions formed, together with the headrest portion, the seat portion, the backrest portion, and the hinge as a single continuous component.

5. The seat assembly of claim 1, wherein the seat portion is securable to the chassis of the automotive vehicle, and wherein the hinge is configured to flex to allow the backrest portion to move with respect to the seat portion to adjust an angle of the backrest portion.

6. The seat assembly of claim 1, wherein the hinge comprises:
a central portion integrally formed with the backrest portion and the seat portion; and
one or more linkage assemblies connected to the central portion and configured to support the central portion when the hinge flexes to allow the relative movement of the backrest portion with respect to the seat portion.

7. The seat assembly of claim 6, wherein the one or more linkage assemblies includes:
a first linkage assembly connected to a first lateral side of the central portion; and
a second linkage assembly connected to a first lateral side of the central portion.

8. The seat assembly of claim 7, wherein one or more of the first linkage assembly and the second linkage assembly includes a plurality of links including gears, the plurality of links engaged with adjacent links via the gears.

9. The seat assembly of claim 8, when the plurality of links of one or more of the first linkage assembly and the second linkage assembly includes a first link connected to the seat portion or the hinge and a second link connected to the backrest portion or the hinge to connect the plurality of links to the seat portion and the backrest portion, respectively.

10. The seat assembly of claim 9, wherein the first link is at least partially integrally formed into the hinge or the seat portion and the second link is at least partially integrally formed into the hinge or the backrest portion.

11. A seat assembly for an automotive vehicle, comprising:
a continuous frame securable to a chassis of the automotive vehicle, the continuous frame comprising:
a seat portion;
a backrest portion; and
a hinge connected to the seat portion and the backrest portion, the hinge configured to flex to allow relative movement of the backrest portion with respect to the seat portion.

12. The seat assembly of claim 11, comprising:
a headrest portion connected to a top of the backrest portion, the headrest portion formed, together with the seat portion, the backrest portion, and the hinge as a single continuous component.

13. The seat assembly of claim 12, wherein the headrest portion and the backrest portion together define a recess configured to receive a soft trim component at least partially therein to secure the soft trim component to the continuous frame.

14. The seat assembly of claim 12, comprising:
a pair of bolster portions connected to laterally opposite sides of the backrest portion below the headrest portion, the pair of bolster portions formed, together with the headrest portion, the seat portion, the backrest portion, and the hinge as a single continuous component.

15. The seat assembly of claim 14, wherein the pair of bolster portions includes a left bolster portion and a right bolster portion located opposite the left bolster portion, wherein the right bolster portion is engageable with a right bolster airbag when deployed to define a right bolster airbag deployment trajectory, and wherein the left bolster portion is engageable with a left bolster airbag when deployed to define a left bolster airbag deployment trajectory.

16. The seat assembly of claim 11, wherein the backrest portion includes one or more ventilation holes formed into the backrest portion, the one or more ventilation holes configured to receive airflow into the continuous frame or deliver airflow from the continuous frame.

17. The seat assembly of claim 11, wherein the seat portion has a first stiffness and the backrest portion has a second stiffness that is different from the first stiffness.

18. The seat assembly of claim 17, wherein the hinge has a third stiffness that is different from the first stiffness and the second stiffness.

19. The seat assembly of claim 18, comprising:
a headrest portion connected to a top of the backrest portion, the headrest portion formed together with the seat portion, the backrest portion, and the hinge as a single continuous component, the headrest portion having a fourth stiffness that is different from the first stiffness, the second stiffness, and the third stiffness.

20. The seat assembly of claim 19, comprising:
a pair of bolster portions connected to laterally opposite sides of the backrest portion below the headrest portion, the pair of bolster portions formed, together with the headrest portion, the seat portion, the backrest portion, and the hinge as a single continuous component, the pair of bolster portions having a fifth stiffness that is different from the first stiffness, the second stiffness, the third stiffness, and the fourth stiffness.

21. The seat assembly of claim 11, wherein the continuous frame is made of a glass nylon composite.
